(19) United States
(12) Patent Application Publication
(10) Pub. No.: US 2004/0131749 A1
(43) Pub. Date: Jul. 8, 2004

(54) Phytochemicals from edible bean process streams

(75) Inventors: Richard D. Grabiel, Decatur, IL (US); Clifford A. Strickland, Decatur, IL (US)

Correspondence Address: STERNE, KESSLER, GOLDSTEIN & FOX PLLC, 1100 NEW YORK AVENUE, N.W., WASHINGTON, DC, 20005, US

(73) Assignee: Archer-Daniels-Midland Company

(21) Appl. No.: 10/651,252

(22) Filed: Aug. 29, 2003

Related U.S. Application Data
(60) Provisional application No. 60/406,691, filed on Aug. 29, 2002.

(51) Int. Cl. A23L 1/36

(52) U.S. Cl. 426/629

(57) ABSTRACT

The invention relates to a composition comprising a phytochemical, in particular, polyphenolic extract derived from a source containing one or more of the following: anthocyanins, flavonols, proanthocyanindins, isoflavones, lectins, saponins, sapogenins, vitamins, minerals and functional proteins. The invention further provides a process for the production of an anthocyanin or flavonol extract from an edible bean source, the process comprising providing the edible beans, contacting the edible beans with an aqueous solution to produce an aqueous extract, and separating the aqueous extract from the edible beans. The invention further provides a method of treating or reducing the probablitity of developing a condition in a human, comprising administering the anthocyanin or flavonol composition of the invention, wherein the condition is selected from the group consisting of cancer, stroke, elevated blood cholesterol, hypertension, myocardial infarction, diabetes, obesity, and inflammatory disorders.

### CROSS-REFERENCE TO RELATED APPLICATIONS

This application claims the benefit of U.S. Provisional Application No. 60/406,691, filed Aug. 29, 2002, the entire contents of which are hereby incorporated by reference.

### BACKGROUND OF THE INVENTION

1. Field of the Invention

The present invention relates, in general, to a process of isolating phytochemical, in particular polyphenolic compounds from commercial edible bean processing waste streams for use as natural colors and functional foods and extracts obtained by such process. These compounds also have potential for use as nutraceutical ingredients in the following health related areas: antioxidants, cardiovascular disease protection, anti-diabetic effects, anti-inflammatory effects, antiviral properties, anti-tumorgenic properties, improvement of night vision, anti-inflammatory activity and anti-stress. The resulting extracts can be formulated for treatment of these conditions. Further utilization can occur for use as cosmetic ingredients and natural colors. The invention also relates to novel compositions comprising extracts prepared by the process of the invention.

2. Related Art

There is an increasing body of research studying biological activity of phytochemical and polyphenolic compounds in fruits and vegetables. Because of the increased research showing health benefits of these compounds, new sources and efficient methods to isolate, quantify, and stabilize phytochemical compounds is of market interest. Described herein is an improved means of producing phytochemical extracts from edible beans. Isolation of the bioactive compounds in quantity will allow further elucidation of individual components and their isolation for biological activity. Many supplements derived from plant sources contain mixtures of phytochemicals that have not been quantified or even identified (Wrolstad, R. E., et al, “An overview of nutraceutical issues and research methods,” presented at North American Blueberry Council, Portland, Oreg. (Jan. 27, 1998)). Examples of compounds of interest are shown in FIG. 1. The isolation of phytochemical compounds also offers value-added components to the processing of edible beans. These types of compounds include anthocyanins, procyanidins flavanols, proanthocyanidins, flavones, lectins, amylase inhibitors, trypsin inhibitors, ellagic acid and other phenolic compounds.

Anthocyanins and flavonoid compounds are sold in the nutraceutical industry for protection against oxidative stress and anti-inflammatory diseases. However, the individual polyphenolic compounds that comprise these extracts need to be further elucidated in order to determine which compound is causing abiological effect. Recently common phenolic compounds such as anthocyanins, quercetin, and catechin, have been shown to modulate the effects of tumor necrosis factor (TNF) (Wang, J. and Mazza, G., J. Agric. Food Chem. 50:4183-4189 (2002)). Other examples of bioactivity include research on the anti-carcinogenic activity due to the ellagic acid rich in strawberry and raspberry (Maas, J. L. and Galletta, G. J., Hort. Sci. 26:10-14 (1991), Maas, J. L., et al., Hort. Sci. 26:66-68 (1991); Perchellet, J.-P., et al., “Antitumor-promoting activities of tannic acid, ellagic acid, and several gallic acid derivatives in mouse skin,” in Plant Polyphenols, Hemingway, R. W. and Laks, P. E., eds., Plenum Press, New York, N.Y. (1992), pp. 783-801; Stoner, G. D. and Mukhtar, H., J. Cell. Biochem. Supp. 22:169-180 (1995); Castonguay, A., et al., Int. J. Oncol. 10:367-373 (1997)); and the effects of anthocyanins from bilberry, chokeberry, and elderberry on eye health (Carlsen, C. and Stapelfeldt, H., Food Chem. 60:383-387 (1997); Nakaishi, H., et al., Altern. Med. Rev. 5:553-562 (2000)) and on cardiovascular health (Abuja, P. M., et al., J. Agric. Food Chem. 46:4091-4096 (1998)). Anthocyanins may also improve night vision by enhancing the activity of metabolic enzymes in the retina. (See De Smet, P. (1983) “Vaccinium myrtillus,” in Adverse Effects of Herbal Drugs, De Smet et al. eds. pp. 307-314, Berlin: Springer-Verlag).

Compounds known as lectins, are another class of phytochemicals from beans with metabolic effects. Lectins are traditionally anti-nutritional factors which can induce multiple types of digestive complications (Boniglia, C., Fedele, E. and Sanzini, E., J. Food Sci. 68(4): 1283-1286 (2003). These problems usually occur if beans are consumed uncooked which doesn't allow inactivation of the proteins through the heating process. Residual lectins in the finished bean product are inactivated by further down stream processing thus eliminating the possibility of complications from any anti-nutritional effect. Lectins and other proteins isolated in this process are being elucidated in order to evaluate their potential uses as deduced by specific biological activity. The legume lectins are proteins that can readily bind with a large variety of carbohydrates (Saron, N. and Lis, H., J. Agric. Food Chem. 50:6586-6591 (2002)). Edible bean varieties contain lectins specific for different types of carbohydrates, but most bind to oligosaccharides. This ability to bind a wide variety of carbohydrates will allow most lectins to agglutinate erythrocytes (“The Lectins. Properties, functions, and Applications in Biology and Medicine,” Leiner, I. E., Sharon, N., and Goldstein, I. J., eds., Academic Press, Inc., Orlando, 1986). The agglutination specificity is as varied as the individual sources of each lectin. Kidney beans contain a number of lectins: PHA-E, PHA-L and Pinto lectin. These biologically active proteins are capable of agglutinating most animal erythrocytes while the lectins from mung bean (MBA, mung bean agglutinin) are specific for trypsinized, rabbit erythrocytes but not human red blood cells. This unique ability allows for the utilization of these compounds to elucidate the cornucopia of unclassified biological pathways. Companies such as Vector Laboratories (Burlingame, Calif.) and Lectinotest Laboratory (Lviv, Ukraine) sell a wide selection of lectins for metabolic research. Lectins isolated in functional form from this process would be intended for this market.

Each fruit and vegetable contains unique compositions of phytochemical compounds. As demonstrated by Saucier and Waterhouse (Saucier, C. T. and Waterhouse, A. L., J. Agric. Food Chem. 47:4491-4494 (1999)) polyphenolics can act together with additive effect as antioxidative compounds. The variability of antioxidant activity for different plant extracts was also demonstrated by Kähkönen et al (Kähkönen, M. P., et al., J. Agric. Food Chem. 47:3954-3962 (1999)) thus demonstrating phenolic composition as pertinent to functionality.

Much of the research into polyphenolic compounds is now focused on fruits and fruit extracts. Anthocyanins occur in fruits such as chokeberries (Plocharski, W. and Zbroszcyzk, J., Fruit Processing 2:85-89 (1992)) and blueberries (Kalt, W., et al., Can. J. Plant Sci. 79:617-623 (1999)). Ellagic acid is present in strawberries (Maas, J. L. and Galletta, G. J., Hort. Sci. 26:10-14 (1991); Maas, J. L., et al, Hort. Sci. 26:66-68 (1991)) and other phenolics such as procyanidins and flavanols are found in many different fruits depending on growing conditions and cultivars (Rommel, A. and Wrolstad, R. E., J. Agric. Food Chem. 41:1237-1241 (1993); Rommel, A. and Wrolstad, R. E., J. Agric. Food Chem. 41:1951-1960 (1993); Prior, R. L., et al., J. Agric. Food Chem. 49:1270-1276 (2001)). However, the presence of many similar compounds of interest is being demonstrated in other plants. The anti-oxidant activity of purple rice extracts was demonstrated in research by Ichikawa et al. (Ichikawa, H., et al., J. Med. Food. 4:211-218 (2001)) and attributed mostly to the presence of a polyphenolic compound called cyanidin-3-glucoside. A number of anthocyanin compounds were characterized and identified in the fruits of different Cornus species (Seeram, N. P., et al., J. Agric. Food Chem. 50:2519-2523 (2002)). Different moieties of the flavonol glycoside kaempferol have been isolated and identified from the seed coat of a Manteca-type dry bean (Phaseolus vulgaris L.) (Beninger, C. W., et al., J. Agric. Food Chem. 46:2906-2910 (1998); Beninger, C. W., et al., “Flavonoid composition of three dry bean (Phaseolu vulgarus L.) seed coat color genotypes.” USDA-ARS Tektran Pubi. (1998); Beninger, C. W. et al., “Natural products chemistry: A new approach to understanding the value of the common bean (Phaseolu vulgarus L.). USDA-ARS Tektran Publ. (1998)). Flavonol glycosides have also been identified in Montcalm Dark Red Kidney Beans (Beninger, C. W. and Hosfield, G. L., Food Chem. 47:4079-4082 (1999)). And further, the anthocyanin composition of black beans was characterized by Takeoka et al. (1997). This research points to the potential for a significant source of polyphenolic compounds from edible beans (dry beans) for study and or commercialization.

The prior art discloses that polyphenolic compounds, in particular anthocyanins, are isolated from edible beans by an alcohol extraction process. Surprisingly, the inventors have discovered that commercially significant quantities of these compounds are present in the aqueous waste streams from commercial edible bean processing. Given the popularity of beans in the human diet and the large, commercial scale of edible bean processing, these unexpected results provide an abundant and unappreciated source for polyphenolic compounds.

### SUMMARY OF THE INVENTION

The invention relates to a composition comprising an anthocyanin extract or a flavonol extract derived from an edible bean source.

In one embodiment, the invention relates to a composition comprising an anthocyanin or a flavonol extract derived from an edible bean source wherein said composition comprises from about 0.005% to about 99%, or more preferably from about 0.5% to about 99%, or more preferably from about 1% to about 90%, or more preferably from about 5% to about 80%, or more preferably from about 10% to about 70%, or more preferably from about 20% to about 60%, or more preferably about 50% to about 60% of anthocyanins or flavonols on a dry weight basis.

In one embodiment, the invention relates to a composition comprising an anthocyanin or flavonol extract derived from an edible bean source wherein said composition comprises from about 0.005% to about 99%, or more preferably from about 0.5% to about 99%, or more preferably from about 1% to about 90%, or more preferably from about 5% to about 80%, or more preferably from about 10% to about 70%, or more preferably from about 20% to about 60%, or more preferably about 50% to about 60% of anthocyanins or flavonols on a dry weight basis and a substance or substances selected from the group consisting of isoflavones, lignans, saponins, catechins, phenolic acids, sapogenins, sterols, and a combination thereof.

In one embodiment, the invention relates to a composition comprising an anthocyanin or flavonol extract from an edible bean source wherein said composition comprises from about 0.005% to about 99%, or more preferably from about 0.5% to about 99%, or more preferably from about 1% to about 90%, or more preferably from about 5% to about 80%, or more preferably from about 10% to about 70%, or more preferably from about 20% to about 60%, or more preferably about 50% to about 60% of anthocyanins or flavonols on a dry weight basis, and one or more isoflavones, wherein the ratio of anthocyanins or flavonols to isoflavones on a molar basis is greater than the value selected from the group consisting of 0.0001, 0.001, 0.01, 0.1, 1.0, 10, 100, 1000, 10,000, and 100,000, preferably about 0.0001 to about 100,000. In another embodiment, the ratio of anthocyanins or flavonols to isoflavones on a weight basis in the composition is about than the value selected from the group consisting of 10,000:1, 1000:1, 500:1, 100:1, 50:1, 10:1, 1:1, 0.1:1, 0.01:1, 0.001:1, and 0.0001:1.

In one embodiment, the invention relates to a composition comprising an anthocyanin or flavonol extract from an edible bean source wherein said composition comprises from about 0.005% to about 99%, or more preferably from about 0.5% to about 99%, or more preferably from about 1% to about 90%, or more preferably from about 5% to about 80%, or more preferably from about 10% to about 70%, or more preferably from about 20% to about 60%, or more preferably about 50% to about 60% of anthocyanins or flavonols on a dry weight basis, and one or more lignans, wherein the ratio of anthocyanins or flavonols to lignans on a molar basis is greater than the value selected from the group consisting of 0.0001, 0.001, 0.01, 0.1, 1.0, 10, 100, 1000, 10,000, and 100,000, anthocyanins or flavonols to lignans on a weight basis in the composition is about than the value selected from the group consisting of 10,000:1, 1000:1, 500:1, 100:1, 50:1, 10:1, 1:1, 0.1:1, 0.01:1, 0.001:1, and 0.0001:1.

In one embodiment, the invention relates to a composition comprising an anthocyanin or flavonol extract from an edible bean source wherein said composition comprises from about 0.005% to about 99%, or more preferably from about 0.5% to about 99%, or more preferably from about 1% to about 90%, or more preferably from about 5% to about 80%, or more preferably from about 10% to about 70%, or more preferably from about 20% to about 60%, or more preferably about 50% to about 60% of anthocyanins of flavonols on a dry weight basis, and one or more saponins, wherein the ratio of anthocyanins or flavonols to saponins on a molar basis is about than the value selected from the group consisting of 0.0001, 0.001, 0.01, 0.1, 1.0, 10, 100, 1000, 10,000, and 100,000, preferably about 0.0001 to about 100,000. In another embodiment, the ratio of anthocyanins or flavonols to saponins on a weight basis in the composition is about than the value selected from the group consisting of 10,000:1, 1000:1, 500:1, 100:1, 50:1, 10:1, 1:1, 0.1:1, 0.01:1, 0.001:1, and 0.0001:1.

In one embodiment, the invention relates to a composition comprising an anthocyanin or flavonol extract from an edible bean source wherein said composition comprises from about 0.005% to about 99%, or more preferably from about 0.5% to about 99%, or more preferably from about 1% to about 90%, or more preferably from about 5% to about 80%, or more preferably from about 10% to about 70%, or more preferably from about 20% to about 60%, or more preferably about 50% to about 60% of anthocyanins or flavonols on a dry weight basis, and one or more catechins, wherein the ratio of anthocyanins or flavonols to catechins on a molar basis is greater than the value selected from the group consisting of 0.0001, 0.001, 0.01, 0.1, 1.0, 10, 100, 1000, 10,000, and 100,000, preferably about 0.0001 to about 100,000. In another embodiment, the ratio of anthocyanins or flavonols to catechins on a weight basis in the composition is about than the value selected from the group consisting of 10,000:1, 1000:1, 500:1, 100:1, 50:1, 10:1, 1:1, 0.1:1, 0.01:1, 0.001:1, and 0.0001:1.

In one embodiment, the invention relates to a composition comprising an anthocyanin or flavonol extract from an edible bean source wherein said composition comprises from about 0.005% to about 99%, or more preferably from about 0.5% to about 99%, or more preferably from about 1% to about 90%, or more preferably from about 5% to about 80%, or more preferably from about 10% to about 70%, or more preferably from about 20% to about 60%, or more preferably about 50% to about 60% of anthocyanins or flavonols on a dry weight basis, and one or more sterols, wherein the ratio of anthocyanins or flavonols to sterols on a molar basis is greater than the value selected from the group consisting of 0.0001, 0.001, 0.01, 0.1, 1.0, 10, 100, 1000, 10,000, and 100,000, preferably about 0.0001 to about 100,000. In another embodiment, the ratio of anthocyanins or flavonols to sterols on a weight basis in the composition is about than the value selected from the group consisting of 10,000:1, 1000:1, 500:1, 100:1, 50:1, 10:1, 1:1, 0.1:1, 0.01:1, 0.001:1, and 0.0001:1.

In one embodiment, the invention relates to a composition comprising an anthocyanin or flavonol extract from an edible bean source wherein said composition comprises from about 0.005% to about 99%, or more preferably from about 0.5% to about 99%, or more preferably from about 1% to about 90%, or more preferably from about 5% to about 80%, or more preferably from about 10% to about 70%, or more preferably from about 20% to about 60%, or more preferably about 50% to about 60% of anthocyanins or flavonols on a dry weight basis, and one or more phenolic acids, wherein the ratio of anthocyanins or flavonols to phenolic acids on a molar basis is greater than the value selected from the group consisting of 0.0001, 0.001, 0.01, 0.1, 1.0, 10, 100, 1000, 10,000, and 100,000, preferably about 0.0001 to about 100,000. In another embodiment, the ratio of anthocyanins or flavonols to phenolic acids on a weight basis in the composition is about than the value selected from the group consisting of 10,000:1, 1000:1, 500:1, 100:1, 50:1, 10:1, 1:1, 0.1:1, 0.01:1, 0.001:1, and 0.0001:1.

In one embodiment, the invention relates to a composition comprising an anthocyanin or flavonol extract from an edible bean source wherein said composition comprises from about 0.005% to about 99%, or more preferably from about 0.5% to about 99%, or more preferably from about 1% to about 90%, or more preferably from about 5% to about 80%, or more preferably from about 10% to about 70%, or more preferably from about 20% to about 60%, or more preferably about 50% to about 60% of anthocyanins or flavonols on a dry weight basis, and one or more sapogenins, wherein the ratio of anthocyanins or flavonols to sapogenins on a molar basis is greater than the value selected from the group consisting of 0.0001, 0.001, 0.01, 0.1, 1.0, 10, 100, 1000, 10,000, and 100,000, preferably about 0.0001 to about 100,000. In another embodiment, the ratio of anthocyanins or flavonols to sapogenins on a weight basis in the composition is about than the value selected from the group consisting of 10,000:1, 1000:1, 500:1, 100:1, 50:1, 10:1, 1:1, 0.1:1, 0.01:1, 0.001:1, and 0.0001:1.

In one embodiment, the invention relates to a composition comprising an lectin extract derived from an edible bean source wherein said composition comprises from about 0.005% to about 99%, or more preferably from about 0.5% to about 99%, or more preferably from about 1% to about 90%, or more preferably from about 5% to about 80%, or more preferably from about 10% to about 70%, or more preferably from about 20% to about 60%, or more preferably about 50% to about 60% of lectins on a dry weight basis and a substance or substances selected from the group consisting of isoflavones, lignans, saponins, catechins, phenolic acids, sapogenins, sterols, and a combination thereof, wherein the ratio of the lectins to the substance(s) on a weight basis in the composition is about than the value selected from the group consisting of 10,000:1, 1000:1, 500:1, 100:1, 50:1, 10:1, 1:1, 0.1:1, 0.01:1, 0.001:1, and 0.0001:1.

In one embodiment, the invention relates to a composition comprising an folic acid extract derived from an edible bean source wherein said composition comprises from about 0.0005% to about 99%, or more preferably from about 0.5% to about 80%, or more preferably from about 1% to about 60%, or more preferably from about 2% to about 55%, or more preferably from about 5% to about 40%, or more preferably from about 10% to about 25%, or more preferably about 15% to about 25% of folic acid on a dry weight basis and a substance or substances selected from the group consisting of isoflavones, lignans, saponins, catechins, phenolic acids, sapogenins, sterols, and a combination thereof, wherein the ratio of the folic acid to the substance(s) on a weight basis in the composition is about than the value selected from the group consisting of 10,000:1, 1000:1, 500:1, 100:1, 50:1, 10:1, 1:1, 0.1:1, 0.01:1, 0.001:1, and 0.0001:1.

In addition to the anthocyanin or flavonol compositions described herein, the invention provides a process for the production of an anthocyanin or flavonol extract from an edible bean source, the process comprising providing the edible beans, contacting the edible beans with an aqueous solution to produce an aqueous extract, and separating the aqueous extract from the edible beans.

Another embodiment of the invention relates to a process of producing an anthocyanin or flavonol extract from an edible bean source comprising (a) providing the edible beans; (b) contacting the edible beans in an aqueous solution to produce an aqueous extract; and (c) separating the aqueous extract from the edible beans. The process may further comprise concentrating the extract of (c). Additionally, the process may further comprise drying the concentrated extract.

Another embodiment of the invention relates to a process of producing an anthocyanin or flavonol extract from an edible bean source comprising (a) providing the edible beans; (b) contacting the edible beans in an aqueous solution to produce an aqueous extract; and (c) separating the aqueous extract from the edible beans. The process may further comprise concentrating the extract of (c). Additionally, the process may further comprise contacting the extract with a resin, wherein the resin absorbs polyphenolic compounds, eluting fractions of the extract from the resin to obtain a fractionated extract, and drying the fractionated extract.

The present invention further provides a method of treating or reducing the probablitity of developing a condition in a human, comprising administering an anthocyanin or flavonol composition of the invention, wherein the condition is selected from the group consisting of cancer, stroke, elevated blood cholesterol, hypertension, myocardial infarction, diabetes, obesity, and inflammatory disorders. The present invention further provides a method of alleviating stress in a human, comprising administering the anthocyanin or flavonol composition of the invention. Also provided is a method of improving night-vision in a human, comprising administering the anthocyanin or flavonol composition of the invention.

The various objects, advantages, and embodiments of the invention will be clear from the description that follows.

### BRIEF DESCRIPTION OF THE FIGURES

FIG. 1 illustrates various polyphenolic compounds.

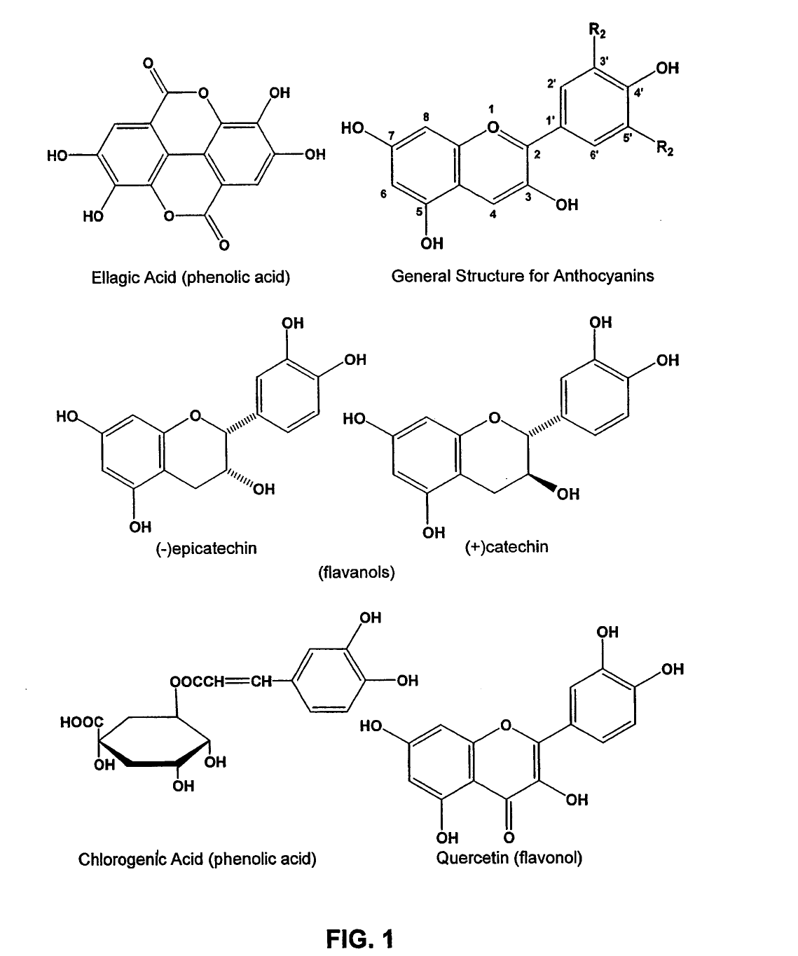

FIG. 2 presents a flow chart illustrating the preferred process of isolation of the anthocyanin or flavonol extract from edible beans.

FIG. 3 presents one embodiment of the invention illustrating an Edible Bean Dehydration Process Flow. The conditioning/blanch water process stream is separated from the beans and subjected to further steps to isolate the desired compounds as shown in FIG. 4.

FIG. 4 presents a flow chart depicting additional embodiments of the process of the isolation of the anthocyanin or flavonol extract from edible beans

### DETAILED DESCRIPTION OF THE INVENTION

The present invention provides a process of obtaining anthocyanin or flavonol compounds comprising isolating the anthocyanin or flavonol compounds from an edible bean processing stream, wherein the isolation step comprises: (a) providing said edible beans; (b) contacting said edible beans with the edible bean processing stream to produce an aqueous extract; and (c) separating said aqueous extract from said edible beans; wherein the edible bean processing stream is an aqueous solution comprising a blanch or conditioning solution employed in edible bean processing. The process of the invention can further comprises concentrating the extract of (c) to form a liquid concentrated extract.

In some embodiments, the extract produced by this process comprises about 0.005% to 30% anthocyanins or 0.001% to 25% flavonols, or both, on a dry weight basis.

In some embodiments the extract comprises 0.5% to 10% anthocyanins or 0.01% to 5.0% flavonols, or both, on a dry weight basis.

In some embodiments, the extract comprises 0.01% to 75% anthocyanins or 0.01% to 50% flavonols, or both, on a dry weight basis.

In some embodiments, the extract comprises 0.1% to 15% anthocyanins or 0.1% to 25% flavonols, or both, on a dry weight basis.

In some embodiments, the process further comprises (a) contacting said concentrated extract with a resin, wherein said resin absorbs anthocyanin or flavonol compounds, or both; (b) eluting a fraction of said absorbed extract from said resin to obtain a fractionated extracts with a solution comprising an organic solvent; and (c) drying said fractionated extract to remove the organic solvent.

The process can further comprise concentrating the extract of (c) to form a liquid concentrated extract. The process can further comprise drying said concentrated extract to form a powder.

In some embodiments, the fractionated extract comprises about 0.1% to about 65% anthocyanins or 0.1% to 50% flavonols, or both, on a dry weight basis. In some embodiments the fractionated extract comprises about 0.1% to about 75% anthocyanins or 0.1% to 65% flavonols, or both, on a dry weight basis. In some embodiments, the fractionated extract comprises about 0.1% to about 90% anthocyanins or 0.1% to 90% flavonols, or both, on a dry weight basis.

In some embodiments, the fractionated extract comprises about 5.0% to about 99.5% anthocyanins or 0.5% to 99% flavonols, or both, on a dry weight basis.

In some embodiments of the invention, the legumes are contacted at about 40 to about 200 degrees Fahrenheit with the aqueous solution, more preferably at about 130 to about 180 degrees Fahrenheit.

The invention provides a composition comprising an anthocyanin or flavonol extract from an edible bean source, said composition comprising from 0.005% to 99% of anthocyanins or 0.005% to 99.0% flavonols, or both, on a dry weight basis and a substance selected from the group consisting of isoflavones, lignans, saponins, catechins, sterols, phenolic acids, sapogenins, and a mixture thereof.

The present invention provides a process of obtaining phytochemicals comprising isolating the phytochemicals from an aqueous edible bean processing stream. The present invention provides a process of obtaining anthocyanins or flavonols comprising isolating the anthocyanins or flavonols from an aqueous edible bean processing stream. The present invention provides a process of obtaining lectins comprising isolating the lectins from an aqueous edible bean processing stream. The present invention provides a process of obtaining isoflavones comprising isolating the isoflavones from an aqueous edible bean processing stream. The present invention provides a process of obtaining folic acid comprising isolating the folic acid from an aqueous edible bean processing stream.

The present invention provides a process of obtaining phytochemical compounds comprising isolating the phytochemical compounds from an edible bean processing stream, wherein the isolation step comprises: providing said edible beans; contacting said edible beans with the edible bean processing stream to produce an aqueous extract; and separating said aqueous extract from said edible beans; wherein the edible bean processing stream is an aqueous solution comprising a blanch or conditioning solution employed in edible bean processing.

The present invention provides a process of obtaining anthocyanin or flavonol compounds comprising isolating the anthocyanin or flavonol compounds from an edible bean processing stream, wherein the isolation step comprises: providing said edible beans; contacting said edible beans with the edible bean processing stream to produce an aqueous extract; and separating said aqueous extract from said edible beans; wherein the edible bean processing stream is an aqueous solution comprising a blanch or conditioning solution employed in edible bean processing. The present invention provides a process of obtaining lectin compounds comprising isolating the lectin compounds from an edible bean processing stream, wherein the isolation step comprises: providing said edible beans; contacting said edible beans with the edible bean processing stream to produce an aqueous extract; and separating said aqueous extract from said edible beans; wherein the edible bean processing stream is an aqueous solution comprising a blanch or conditioning solution employed in edible bean processing.

The present invention provides a process of obtaining folic acid compounds comprising isolating the folic acid compounds from an edible bean processing stream, wherein the isolation step comprises: providing said edible beans; contacting said edible beans with the edible bean processing stream to produce an aqueous extract; and separating said aqueous extract from said edible beans; wherein the edible bean processing stream is an aqueous solution comprising a blanch or conditioning solution employed in edible bean processing.

The present invention provides a process of obtaining isoflavones compounds comprising isolating the isoflavone compounds from an edible bean processing stream, wherein the isolation step comprises: providing said edible beans; contacting said edible beans with the edible bean processing stream to produce an aqueous extract; and separating said aqueous extract from said edible beans; wherein the edible bean processing stream is an aqueous solution comprising a blanch or conditioning solution employed in edible bean processing.

Polyphenols are those compounds which comprise more than one phenolic group. Among the polyphenols are the following classes: flavonoids, flavonols, proanthocyanidins (also called procyanidols, procyanins, procyanidins and tannins) and anthocyanins.

As used herein, the term “isoflavone” includes conjugated glucosides (malonyl and acetyl), glucoside, and aglycone forms of isoflavones.

As used herein, the term “lignan” represents compounds that possess a 2,3-dibenzylbutane structure. They include matairesinol, secoisolariciresinol, lariciresinol, isolariciresinol, nordihydroguaiaretic acid, pinoresinol, olivil, other compounds that may be precursors of enterolactone and enterodiol and modifications thereof, including diglucosides.

The isoflavone, lignan, sterol, saponin, sapogenin, catechin or phenolic acid component of the compositions of the invention can be from any source and is preferably from a plant source. In one embodiment, the isoflavone, lignan, sterol, saponin, sapogenin, catechin or phenolic acid component of the composition is from a source other than an edible bean.

As used herein, an “anthocyanin” is a flavonoid plant pigment that accounts for most of the red, pink, and blue colors in plants, fruits, and flowers. Anthocyanins comprise an aglycone and sugar attached at the 3 or the 3 and 5 positions of the aglycone. Typical examples are: cyanidin (hydroxylated at positions 3, 5, 7, 3′, 4′), delphinidin (hydroxylated at positions 3, 5, 7, 4′, 5′) and pelargonidin (hydroxylated at positions 3, 5, 7, 3′), peonidin, petunidin, and malvidin. The hydroxyl groups are usually glycosylated and/or methoxylated (e.g. malvidin is substituted at the 3′ and 5′ hydroxyl groups and paeonidin and petunidin are substituted at the 3′ hydroxyl group). In addition polymers of these anthocyanins exist which are classified as polymeric anthocyanins.

As used herein, the term “catechin” represents those compounds that are flavan-3-ols, which may include epigallocatechin, catechin, epicatechin, and gallocatechin.

As used herein, the term “quercitin” and “kaempferol” refer to flavonol compounds comprising the quercitin or kaempferol base unit and any sugar that may be attached. Similarly, the terms “petunidin,” “delphinidin,” “peonidin,” “malvidin,” “pelargonidin,” and “cyaniding” refer to anthocyanin compounds comprising the base unit and any sugar that may be added.

As used herein, the term “saponin” represents those compounds that are 3-O-glycosides of the parent steroid or triterpene. Saponins include glucosides of sapogenin such as triterpenoide or steroids and saccharides such as glucose, arabinose, galactose, or glucuronic acid.

As used herein, a “natural colorant” is a colorant suitable for food and beverage applications, is derived solely from natural pigments, contains no synthetic dyes, and is obtained by use of a physical separation process.

As used herein, “food” or “beverage” represents any ingested nutrition and/or energy source. For example, baked goods, staples, drinks, such as soft drinks, fruit and vegetable juices, sports beverages such as POWERADE and GATORADE, prepared foods such as frozen or non-frozen packaged foods, etc., all would be useful vehicles for the compositions and uses of the present invention. In addition to traditional food products, the present invention is useful in the preparation and consumption of nutraceutical products, such as health and dietary supplements and “health food” products. Examples of health food products include energy bars, breakfast bars, and shakes or beverages.

As used herein “isolated” or “purified” is a term meaning altered “by the hand of man” from the natural state. An extract is considered isolated or purified in the sense that the constituents that make up the extract have been removed from their natural source.

The aqueous edible bean processing stream is preferably that produced in the commercial processing of edible beans for human and/or animal consumption. The edible beans can be of any type and preferably are selected from the group consisting of black beans, red beans, kidney beans, dark red kidney beans, light red kidney beans, lentils, garbonzo beans, broadbeans, cowpeas, lima beans, chick peas, mung beans, mungo beans, peas, pigeon peas, yardlong beans, winged beans, lupins, pinto beans, white beans, great northern beans, mayo copa beans, french beans, and cranberry beans. Alternatively, legumes that are non-edible can also be used in the process of the invention.

The phytochemicals of the invention include polyphenolic compounds, sapogenins, saponins, sterols, lignans, catechins, lectins and folic acid.

The polyphenolic compounds of the invention are selected from the group consisting of anthocyanins, flavonols, proanthocyanindins, and isoflavones. In a specific embodiment, the polyphenolic compounds of the invention are anthocyanins or flavonols.

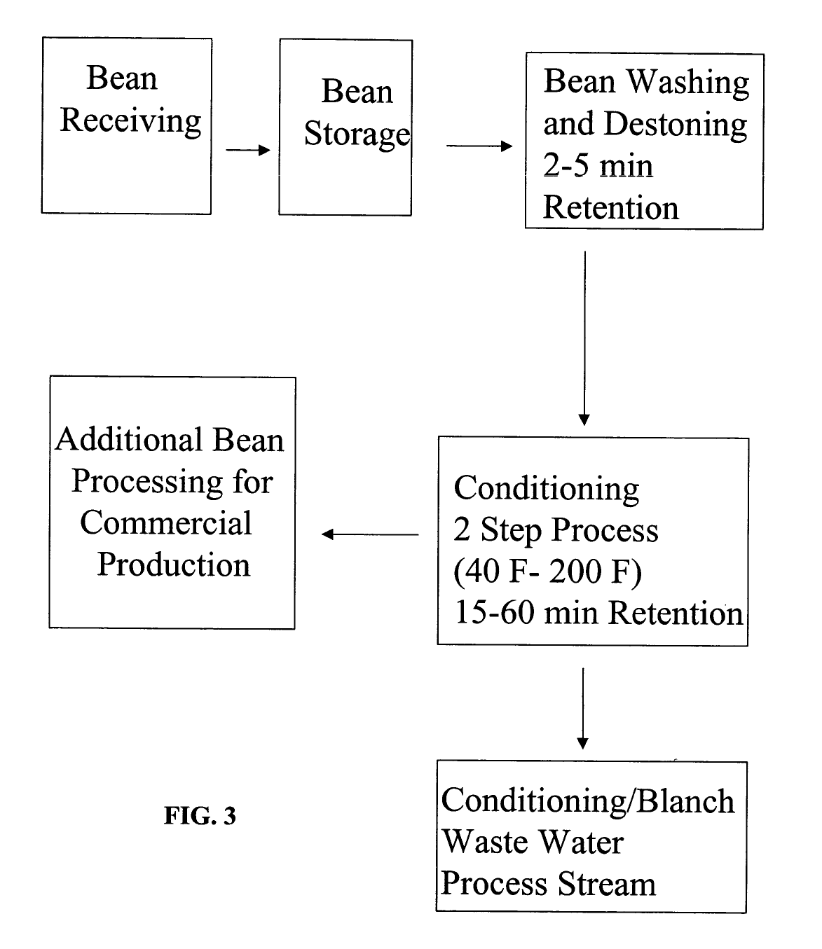

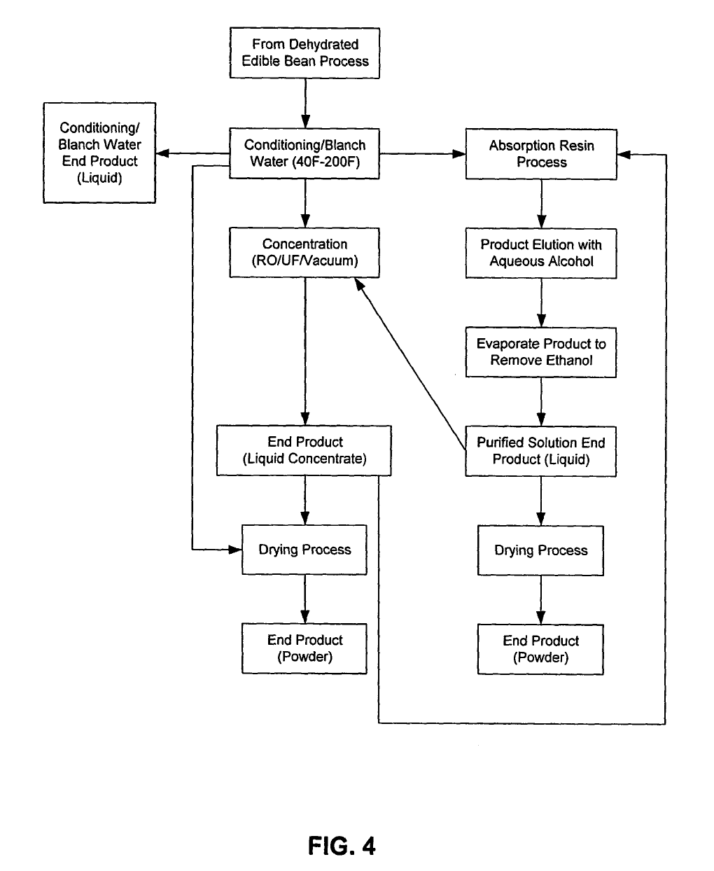

The isolation step of the process comprises contacting the edible beans with an aqueous processing stream to produce an aqueous extract and separating the aqueous extract from the edible beans. The aqueous extract produced in this manner contains significant amounts of polyphenolic compounds such as anthocyanins and/or flavonols, lectins and folic acid and can be used as a value added ingredient in food, beverage and nutraceutical applications. The aqueous extract is particularly useful as a colorant. The isolation step may further comprise concentrating the aqueous extract after it has been separated from the edible beans to yield a liquid concentrated extract. In another embodiment, the aqueous extract can be dried to yield a powder. The liquid concentrate can optionally be dried to yield a powder. The drying can process can be any drying process known by those skilled in the art, including vacuum belt drying, drum drying, spray drying, and freeze drying. In one embodiment, the drying process is by freeze drying. The concentration of the aqueous extract can be by reverse osmosis, ultrafiltration or by vacuum. The liquid concentrated extract (or the powder resuspended in a vehicle) can be further purified by contacting the liquid concentrated extract (or resuspended powder) with a resin that is able to absorb any one of the following: anthocyanins, flavonols, proanthocyanindins, isoflavones, lectins and folic acid. Chromatographic techniques suitable for the isolation of polyphenolic compounds are described by Cardador-Martinez et al., J. Agric. Food Chem. 50(24):6975-80 (2002) and Cai et al., J. Agric. Food Chem. 51(6):1623-1627 (2003), and Revilla et al., J Chromatogr A. 915(1-2):53-60 (2001). The fractions are then eluted from the absorbed resin to obtain a fractionated extract. The fractions can be eluted with an aqueous organic solvent, such as aqueous ethanol or methanol. The fractions can then be dried to remove residual organic solvent. The fractionated extracts can then be further concentrated by reverse osmosis, ultrafiltration or vacuum to yield a liquid concentrated product, or may optionally dried by a drying process wherein the drying process is selected from the group consisting of vacuum belt drying, drum drying, spray drying and freeze drying. The liquid concentrated product can optionally be dried to remove all liquid and moisture to yield a powder by the aforementioned drying process. Some embodiments of the process of the invention are shown in FIGS. 3 and 4. In some embodiments, the aqueous extract can be applied directly to the resin and processed as described above thereby avoiding the concentration step by reverse osmosis, ultrafiltration or vacuum.

Content determination of the extracts can be performed by any known methods in the art. For example, anthocyanin content can be determined by the method of Padmavati et al., Phyochemistry 46:499-502 (1997). Water or moisture content can be quantified by method no. 934.01 of AOAC, crude fat by method nos. 954.02 of AOAC or Bc 3-49 of AOCS, crude protein by method nos. 984.13 of AOAC or Ba 3-49 of AOCS, crude fiber by method no. 962.09 of AOAC, ash content by method nos. 900.02 of AOAC or Ba 5a-49 of AOCS, and folic acid by method no. 944.12 of AOAC. Isoflavone content may be quantified by the methods described in J Chromatog. A, 913(2001) 397-413.

Another embodiment of the invention relates to a process of producing an anthocyanin, flavonol, lectin, folic acid, or isoflavone extract from an edible bean source comprising (a) providing the edible beans; (b) contacting the edible beans in an aqueous solution to produce an aqueous extract; and (c) separating the aqueous extract from said edible beans. The process may further comprise concentrating the extract of (c). Additionally, the process may further comprise drying said concentrated extract.

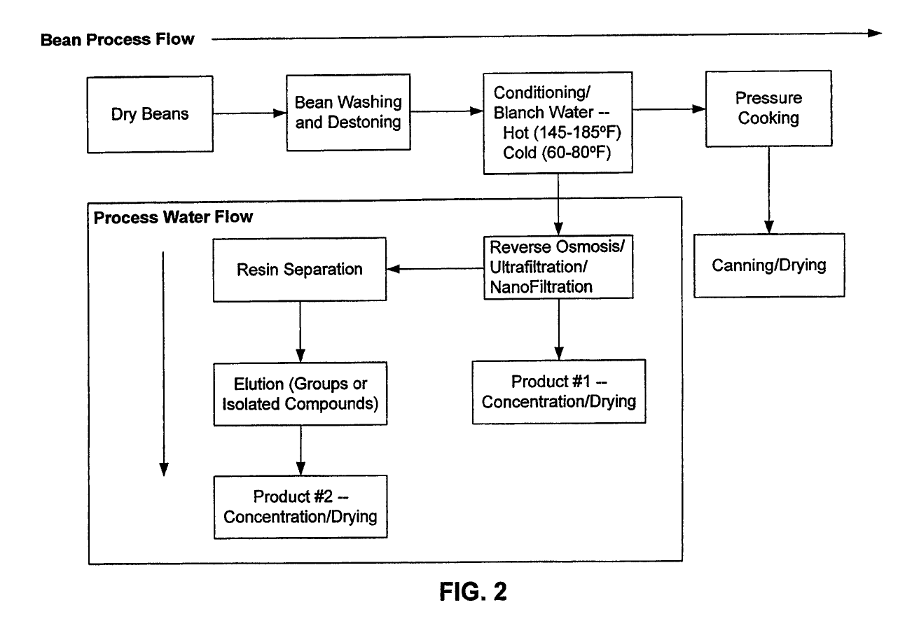

Another embodiment of the invention relates to a process of producing an anthocyanin, flavonol, lectin, folic acid, or isoflavone extract from an edible bean source comprising (a) providing the edible beans; (b) contacting the edible beans in an aqueous solution to produce an aqueous extract; and (c) separating the aqueous extract from the edible beans. The process may further comprise concentrating the extract of (c). Additionally, the process may further comprise contacting the extract with a resin, wherein the resin absorbs polyphenolic compounds selected from the group consisting of anthocyanins, flavonols, isoflavones and proanthocyanidins. In another embodiment, the resin can absorb lectins and folic acid. The process further comprises eluting fractions of the extract from the resin to obtain a fractionated extract, and drying the fractionated extract. A flow chart illustrating the process is shown in FIGS. 2, 3 and 4.

The edible bean source of the process of the invention may be from any edible bean. In one embodiment, the edible bean source is from a dry edible bean. Examples of edible beans which may be used in the process of the invention include, but are not limited to black beans, kidney beans, lentils, chickpeas, broadbeans, cowpeas, lima beans, mung beans, mungo beans, peas, pigeon peas, yardlong beans, winged beans, lupins, pinto beans, white beans, great northern beans, french beans, and cranberry beans. Alternatively, legumes that are non-edible can also be used in the process of the invention.

The aqueous edible bean processing stream solution that contacts and blanches or conditions the edible beans can be any aqueous solution, provided that the solution does not contain alcohol. The solution can consist entirely of water, or the solutions can be comprised of one or more of the following: inorganic salts or buffering agents (such as calcium chloride, tri-sodium phosphate, tri-calcium phosphate, sodium hexa-metaphosphate (HMP), sodium chloride, potassium chloride, EDTA, ammonium bicarbonate, calcium bicarbonate), acids (such as hydrochloric acid) and organic acids (such as malic, lactic, ascorbic and citric). Buffering agents and salts are used over a possible range of about 0% to about 10%, more preferably about 0% to about 5.0%, more preferably about 0.2% to about 0.75% by volume of solution. Buffering agents and salts can also be used over a possible range of about 0% to about 10%, more preferably about 0% to about 5.0%, more preferably about 1.0% to about 5.0% by wt. of the processed edible beans. In one embodiment the aqueous solution that contacts the edible beans lacks acids and organic acids. In another embodiment, the aqueous solution lacks sulfite ions and acids and organic acids.

Calcium chloride may be added to the contacting aqueous solution at about 0.1% to about 1% of the volume of the solution, preferably about 0.2% to about 0.7%. The amount of calcium chloride added may also be based on the dry weight of the edible beans, thereby adding about 0% to about 10% calcium chloride to the solution, more preferably about 0.5% to about 5%, more preferably about 1% to about 5% calcium chloride.

Organic acids may also be components of the contacting solution, at an amount ranging between 0% to about 10%, more preferably 0.1% to about 5%, more preferably about 0.2% to about 3% by volume of solution or weight of the processed beans. The organic acids that may be employed include one or more of acetic acid, citric acid, gluconic acid gluconolactonic acid, lactic acid, ascorbic acid, malic acid, their salts, and mixtures thereof.

The edible beans may be contacted with the aqueous solution for about 1 to about 720 minutes. In one embodiment, the edible beans are contacted with the aqueous solution for about 1 to about 480 minutes In one embodiment, the edible beans are contacted with the aqueous solution for about 1 to about 400 minutes. In another embodiment, the edible beans are contacted with the aqueous solution for about 1 to about 375 minutes. In another embodiment, the edible beans are contacted with the aqueous solution for about 1 to about 350 minutes. In another embodiment, the edible beans are contacted with the aqueous solution for about 1 to about 300 minutes. In another embodiment, the edible beans are contacted with the aqueous solution for about 1 to about 250 minutes. In another embodiment, the edible beans are contacted with the aqueous solution for about 1 to about 200 minutes. In another embodiment, the edible beans are contacted with the aqueous solution for about 1 to about 150 minutes. In another embodiment, the edible beans are contacted with the aqueous solution for about 1 to about 100 minutes. In another embodiment, the edible beans are contacted with the aqueous solution for about 1 to about 75 minutes. In another embodiment, the edible beans are contacted with the aqueous solution for about 5 to about 75 minutes. In another embodiment, the edible beans are contacted with the aqueous solution for about 15 to about 75 minutes. In another embodiment, the edible beans are contacted with the aqueous solution for about 25 to about 75 minutes. In another embodiment, the edible beans are contacted with the aqueous solution for about 35 to about 75 minutes. In another embodiment, the edible beans are contacted with the aqueous solution for about 45 to about 75 minutes. In another embodiment, the edible beans are contacted with the aqueous solution for about 55 to about 75 minutes. In another embodiment, the edible beans are contacted with the aqueous solution for about 65 to about 75 minutes. In another embodiment, the edible beans are contacted with the aqueous solution for about 70 to about 75 minutes. In another embodiment, the edible beans are contacted with the aqueous solution for about 10 to about 50 minutes, more preferably for about 15 to about 40 minutes, more preferably for about 20 to about 30 minutes.

In accordance with the process of the present invention, the edible beans may be contacted with the aqueous solution at either a low or a high temperature. Contacting fruits or vegetables with a solution at a high temperature is known as “blanching” in the art. For example, the edible beans may be contacted with a high temperature solution of about 100 to about 300 degrees Fahrenheit. In another embodiment, the edible beans are contacted with a high temperature solution of from about 100 to about 280 degrees Fahrenheit. In another embodiment, the edible beans are contacted with a high temperature solution of from about 100 to about 260 degrees Fahrenheit. In another embodiment, the edible beans are contacted with a high temperature solution of from about 100 to about 240 degrees Fahrenheit. In another embodiment, the edible beans are contacted with a high temperature solution of from about 100 to about 220 degrees Fahrenheit. In another embodiment, the edible beans are contacted with a high temperature solution of from about 100 to about 200 degrees Fahrenheit. In another embodiment, the edible beans are contacted with a high temperature solution of from about 100 to about 260 degrees Fahrenheit. In another embodiment, the edible beans are contacted with a high temperature solution of from about 100 to about 185 degrees Fahrenheit. In another embodiment, the edible beans are contacted with a high temperature solution of from about 120 to about 185 degrees Fahrenheit. In another embodiment, the edible beans are contacted with a high temperature solution of from about 140 to about 185 degrees Fahrenheit. In another embodiment, the edible beans are contacted with a high temperature solution of from about 160 to about 185 degrees Fahrenheit. In another embodiment, the edible beans are contacted with a high temperature solution of from about 180 to about 185 degrees Fahrenheit.

In another embodiment the edible beans may be contacted with a low temperature solution. For example, the edible beans may be contacted with a low temperature solution of about 0 to about 99 degrees Fahrenheit. In another embodiment, the edible beans are contacted with a low temperature solution of from about 10 to about 99 degrees Fahrenheit. In another embodiment, the edible beans are contacted with a low temperature solution of from about 20 to about 99 degrees Fahrenheit. In another embodiment, the edible beans are contacted with a low temperature solution of from about 30 to about 99 degrees Fahrenheit. In another embodiment, the edible beans are contacted with a low temperature solution of from about 40 to about 99 degrees Fahrenheit. In another embodiment, the edible beans are contacted with a low temperature solution of from about 50 to about 99 degrees Fahrenheit. In another embodiment, the edible beans are contacted with a low temperature solution of from about 60 to about 99 degrees Fahrenheit. In another embodiment, the edible beans are contacted with a low temperature solution of from about 60 to about 90 degrees Fahrenheit. In another embodiment, the edible beans are contacted with a low temperature solution of from about 60 to about 80 degrees Fahrenheit.

The edible beans may be contacted only once with the aqueous solution, or they may be contacted more than one time. For example, the edible beans may be contacted with a low temperature conditioning aqueous solution at 40 degrees Fahrenheit for 30 minutes, followed by removal of the solution and then blanched with an aqueous solution at a higher temperature at 200 degrees Fahrenheit for an additional 30 minutes.

In accordance with some embodiments of the invention, the extract may be concentrated following separation from the edible beans. Concentration may be performed by methods well known in the art, and include but are not limited to reverse osmosis, vacuum drying, evaporation, ultrafiltration, nanofiltration, and precipitation.

In accordance with some embodiments of the invention, the process may comprise separation and purification of the phytochemical, in particular polyphenolic, folic acid, or lectin extract by chromatography. These processes include, but are not limited to gas chromatography, liquid chromatography, ion exchange chromatography, and affinity chromatography. Accordingly, the chromatographic process of the invention will utilize resins in the separation process. The resin maybe of any type, form, composition, or substance, provided that the resin is capable of absorbing and/or separating phytochemicals, in particular polyphenolic compounds. Particularly preferred resins are those that absorb anthocyanins or flavonols. Additionally, resins can be used that absorb lectins or folic acid, to further isolate these compounds. Preferably, the resin is a food-grade resin (See 21 C.F.R. 173.65). The resin may act to absorb the polyphenolic, lectin or folic acid compounds, or may act by a filtration mechanism as in gel filtration chromotography. Examples of types of resins that are suitable for the process of the invention include, but are not limited to ion exchange, hydrophobic, gel filtration, and affinity resins. Representative resins that may be used in the process of the invention include, but are not limited to Purolite AP-250, trimethylolpropane trimethacrylate, Dowex cation exchange, Amberlite XAD, Sephadex G-25 resin, Polyamide resin, Diaion HP-20, carboxymethyl cellulose/sephadex, sulfopropyl sephadex, diethylaminoethyl celluluse/sephadex, quarternary amine sephadex, hydroxyapatite, divinylbenzene (DVB), and polystyrene cross-linked to DVB. After absorption of the anthocyanin or flavonol extract on the chromatographic resin, the anthocyanin or flavonol-enriched fractions may then be eluted from the resin (typically following a washing step) by use of a suitable organic solvent (such as ethanol, methanol, acetone, ethyl acetate, dimethylene chloride, and chloroform), which may also contain water. The organic solvent is preferably relatively volatile (i.e. having a boiling point of between 30 and 85 degrees C. at 760 mm Hg pressure) and so readily driven off, to leave a substantially dry (i.e. less than 10% w/w H₂O) solid composition comprising anthocyanins, flavonols, other phytochemical or polyphenolic compounds, lectins or folic acid or any combination thereof. Preferably, the extract is eluted with an aqueous ethanol solution. The ethanol content of the solution maybe from 1% to about 100% ethanol, more preferably about 20 to about 80%, where an ethanol content of about 70% is preferred. Following elution, the fractionated extracts may be further concentrated or dried by evaporation, or under vaccuum, for example.

The artisan will also appreciate that the contents of the liquid concentrated extract produced by ultrafiltration or nanofiltration of the aqueous extract or fractionated extracts can be size-excluded from passage through the membrane by selection of membranes with various pore sizes or molecular weight cutt-offs. Such techniques allow for further purification and isolation of phytochemicals of the invention. Such techniques are also useful in the sterilization of the solutions, as bacteria and yeasts can not penetrate the membranes.

In one embodiment, the extract produced from the edible bean by the process of the invention comprises about 0.0005% to about 99% anthocyanins on a dry weight basis. In another embodiment, the extract produced by the process of the invention comprises about 0.5% to about 99% anthocyanins. In another embodiment, the extract produced by the process of the invention comprises about 1.0% to about 90% anthocyanins. In another embodiment, the extract produced by the process of the invention comprises about 5.0% to about 80% anthocyanins. In another embodiment, the extract produced by the process of the invention comprises about 10% to about 70% anthocyanins. In another embodiment, the extract produced by the process of the invention comprises about 20% to about 60% anthocyanins. In another embodiment, the extract produced by the process of the invention comprises about 50% to about 60% anthocyanins. In another embodiment, the extract produced by the process of the invention comprises about 0.01% to about 25.0% anthocyanins, more preferably about 0.1% to about 15.0% anthocyanins, more preferably about 1.0% to about 10% anthocyanins on a dry weight basis.

In one embodiment, the extract produced from the edible beans by the process of the invention comprises about 0.0005% to about 99% flavonols on a dry weight basis. In another embodiment, the extract produced by the process of the invention comprises about 0.5% to about 99% flavonols. In another embodiment, the extract produced by the process of the invention comprises about 1.0% to about 90% flavonols. In another embodiment, the extract produced by the process of the invention comprises about 5.0% to about 80% flavonols. In another embodiment, the extract produced by the process of the invention comprises about 10% to about 70% flavonols. In another embodiment, the extract produced by the process of the invention comprises about 20% to about 60% flavonols. In another embodiment, the extract produced by the process of the invention comprises about 50% to about 60% flavonols. In another embodiment, the extract produced by the process of the invention comprises 0.01% to 25.0% flavonols, more preferably about 0.1% to about 15.0% flavonols, more preferably about 1.0% to about 10% flavonols on a dry weight basis.

In one embodiment, the extract produced from the edible bean by the process of the invention comprises about 0.001% to about 85.0% folic acid on a dry weight basis, more preferably about 0.01% to about 50.0%, more preferably about 1.0% to about 30.0% folic acid.

In one embodiment, the extract produced from the edible bean by the process of the invention comprises about 0.001% to about 99.0% isoflavones on a dry weight basis, more preferably about 0.1% to about 60.0%, more preferably about 0.01% to about 1.0% isoflavones.

In one embodiment, the extract produced from the lugume by the process of the invention comprises about 0.01% to about 85.0% lectins on a dry weight basis, more preferably about 0.1% to about 25.0%, more preferably about 1.0% to about 10.0% lectins.

In one embodiment, the extract produced by the process of the invention is from the black bean. The black bean extract comprises an anthocyanin selected from the group consisting of petunidin, delphinidin, peonidin, malvidin and a combination thereof. In a further embodiment, the black bean extract further comprises the flavonols quercitin and kaempferol and combinations therof. The black bean extract produced by the process of the invention can also comprise isoflavones and folic acid. In one embodiment, the black bean extract comprises the following flavonols and anthocyanins on a dry weight basis: 1) petunidin 3-glucoside of from 0.10 to about 800 mg/g, preferably from about 0.50 to about 500.0 mg/g, more preferably about 1.0 to about 50.0 mg/g, more preferably from about 3.0 to about 7.0 mg/g; 2) delphinidin 3-glucoside of from about 0.10 to about 700 mg/g, preferably from about 0.50 to about 100.0 mg/g, more preferably about 1.0 to about 50.0 mg/g, more preferably from about 3.0 to about 10.0 mg/g; 3) peonidin 3-glucoside of from about 0.001 to about 250 mg/g, preferably about 0.01 to about 50.0 mg/g, more preferably from about 0.10 to about 10 mg/g, more preferably from about 0.10 to about 1.0 mg/g; 4) malvidin 3-glucoside of from about 0.10 to about 200 mg/g, preferably from about 0.50 to about 50.0 mg/g, more preferably about 1.0 to about 10.0 mg/g, more preferably from about 3.0 to about 7.0 mg/g; 5) quercitin of from about 0.001 to about 250 mg/g, preferably about 0.01 to about 50 mg/g, more preferably from about 0.10 to about 1.0 mg/g; and 6) kaempferol of from about 0.001 to about 100 mg/g, preferably about 0.01 to about 50 mg/g, more preferably from 0.10 to 1.0 mg/g.

In one embodiment, the extract produced by the process of the invention is from the light red kidney bean. The light red kidney bean extract comprises an anthocyanin selected from the group consisting of petunidin, delphinidin, peonidin, malvidin, pelargonidin, cyanidin, and a combination thereof. In a further embodiment, the light red kidney bean extract further comprises the flavonols quercitin and kaempferol. The light red kidney bean extract produced by the process of the invention can also comprise isoflavones and folic acid. In one embodiment, the light red kidney bean extract comprises the following flavonols and anthocyanins on a dry weight basis: 1) petunidin 3-glucoside of from about 0.10 to about 500 mg/g, preferably from about 0.50 to about 100 mg/g, more preferably about 1.0 to about 10.0 mg/g, more preferably from about 3.0 to about 7.0 mg/g; 2) delphinidin 3-glucoside of from about 0.10 to about 250 mg/g, preferably from about 0.50 to about 25.0 mg/g, more preferably about 1.0 to about 10.0 mg/g, more preferably from about 3.0 to about 7.0 mg/g; 3) peonidin 3-glucoside of from about 0.001 to about 100 mg/g, preferably about 0.01 to about 50 mg/g, more preferably from about 0.10 to about 1.0 mg/g; 4) malvidin 3-glucoside of from about 0.10 to about 200 mg/g, preferably from about 0.50 to about 25.0 mg/g, more preferably about about 1.0 to about 10.0 mg/g, more preferably from about 3.0 to about 7.0 mg/g; 5) quercitin of from about 0.001 to about 250 mg/g, preferably about 0.01 to about 50 mg/g, more preferably from about 0.10 to about 1.0 mg/g; and 6) kaempferol of from about 0.001 to about 100 mg/g, preferably about 0.01 to about 50 mg/g, more preferably from about 0.10 to about 1.0 mg/g.

In one embodiment, the extract produced by the process of the invention is from the dark red kidney bean. The dark red kidney bean extract comprises an anthocyanin selected from the group consisting of petunidin, peonidin, malvidin and a combination thereof. In a further embodiment, the dark red kidney bean extract further comprises the flavonols quercitin and kaempferol. The dark red kidney bean extract produced by the process of the invention can also comprise isoflavones and folic acid. In one embodiment, the dark red kidney bean extract comprises the following flavonols and anthocyanins on a dry weight basis: 1) petunidin 3-glucoside of from about 0.001 to about 500 mg/g, more preferably from about 0.01 to about 100 mg/g, more preferably from about 0.01 to about 10 mg/g, more preferably from about 0.01 to about 1.0 mg/g; 2) peonidin 3-glucoside of from about 0.001 to about 300 mg/g, more preferably from about 0.01 to about 100 mg/g, more preferably from about 0.01 to about 10 mg/g, more preferably from about 0.01 to about 1.0 mg/g; 3) malvidin 3-glucoside of from about 0.001 to about 200 mg/g, more preferably from about 0.01 to about 10 mg/g, more preferably from about 0.01 to about 1.0 mg/g; 4) quercitin of from about 0.01 to about 250 mg/g, preferably about 0.1 to about 25.0 mg/g, more preferably from about 1.0 to about 10.0 mg/g; and 5) kaempferol of from about 0.001 to about 100 mg/g, preferably about 0.01 to about 50 mg/g, more preferably from about 0.10 to about 1.0 mg/g.

In one embodiment, the extract produced by the process of the invention is from the chick pea. The chick pea extract comprises an anthocyanin selected from the group consisting of petunidin, delphinidin, peonidin, malvidin and a combination thereof. In a further embodiment, the chick pea extract further comprises the flavonols quercitin and kaempferol. The chick pea extract produced by the process of the invention can also comprise isoflavones and folic acid. In one embodiment, the chick pea extract comprises the following flavonols and anthocyanins on a dry weight basis: 1) petunidin 3-glucoside of from about 0.001 to about 400 mg/g, preferably from about 0.050 to about 25.0 mg/g, more preferably about 1.0 to about 10.0 mg/g, more preferably from about 3.0 to about 7.0 mg/g; 2) delphinidin 3-glucoside of from about 0.01 to about 500 mg/g, preferably from about 0.50 to about 100 mg/g, more preferably about 1.0 to about 10.0 mg/g, more preferably from about 3.0 to about 7.0 mg/g; 3) peonidin 3-glucoside of from about 0.001 to about 250 mg/g, preferably about 0.01 to about 25 mg/g, more preferably from about 0.10 to about 1.0 mg/g; 4) malvidin 3-glucoside of from about 0.10 to about 250 mg/g, preferably from about 0.50 to about 25.0 mg/g, more preferably about 1.0 to about 10.0 mg/g, more preferably from about 3.0 to about 7.0 mg/g; 5) quercitin of from about 0.001 to about 200 mg/g, preferably about 0.01 to about 50 mg/g, more preferably from about 0.10 to about 1.0 mg/g; and 6) kaempferol of from about 0.001 to about 250 mg/g, preferably about 0.01 to about about 50 mg/g, more preferably from about 0.10 to about 1.0 mg/g.

In one embodiment, the extract produced by the process of the invention is from the red bean. The red bean extract comprises an anthocyanin selected from the group consisting of petunidin, peonidin, malvidin and a combination thereof. In a further embodiment, the red bean extract further comprises the flavonols quercitin and kaempferol. The red bean extract produced by the process of the invention can also comprise isoflavones and folic acid. In one embodiment, the red bean extract comprises the following flavonols and anthocyanins on a dryweight basis: 1) petunidin 3-glucoside of from about 0.001 to about 500 mg/g, preferably from about 0.050 to about 100 mg/g, more preferably about 1.0 to about 10.0 mg/g, more preferably from about 3.0 to about 7.0 mg/g; 2) peonidin 3-glucoside of from about 0.001 to about 300 mg/g, preferably about 0.01 to about 50 mg/g, more preferably from about 0.10 to about 1.0 mg/g; 3) malvidin 3-glucoside of from about 0.10 to about 500 mg/g, preferably from about 0.50 to about 50 mg/g, more preferably about 1.0 to about 10.0 mg/g, more preferably from about 3.0 to about 7.0 mg/g; 4) quercitin of from about 0.001 to about 250 mg/g, preferably about 0.01 to about 50 mg/g, more preferably from about 0.10 to about 10 mg/g, more preferably from about 0.10 to about 1.0 mg/g; and 5) kaempferol of from about 0.001 to about 100 mg/g, preferably about 0.01 to about 5.0 about mg/g, more preferably from about 0.10 to about 1.0 mg/g.

Extracts of the invention are from edible beans sources. The edible beans can be of any type and preferably are selected from the group consisting of black beans, red beans, kidney beans, dark red kidney beans, light red kidney beans, lentils, garbonzo beans, broadbeans, cowpeas, lima beans, chick peas, mung beans, mungo beans, peas, pigeon peas, yardlong beans, winged beans, lupins, pinto beans, white beans, great northern beans, mayo copa beans, french beans, and cranberry beans. Alternatively, legumes that are non-edible can also be used to make extracts of the invention.

The invention further relates to a composition comprising an anthocyanin, flavonol, isoflavone, folic acid or lectin extract derived from an edible bean source. In preferred embodiments, the extract comprising the composotion is produced by the process of the invention.

In one embodiment, the invention relates to a composition comprising an anthocyanin or a flavonol extract from an edible bean source wherein said composition comprises from about 0.005% to about 99%, or more preferably from about 0.5% to about 99%, or more preferably from about 1% to about 90%, or more preferably from about 5% to about 80%, or more preferably from about 10% to about 70%, or more preferably from about 20% to about 60%, more preferably about 50% to about 60% of anthocyanins or flavonols on a dry weight basis.

In one embodiment, the invention relates to a composition comprising a lectin extract from an edible bean source wherein said composition comprises from about 0.005% to about 90%, or more preferably from about 0.5% to about 80%, or more preferably from about 5% to about 70%, or more preferably from about 10% to about 50%, or more preferably from about 15% to about 35%, or more preferably from about 20% to about 25% of lectins on a dry weight basis.

In one embodiment, the invention relates to a composition comprising an anthocyanin or flavonol extract from an edible bean source wherein said composition comprises from about 0.005% to about 99%, or more preferably from about 0.5% to about 99%, or more preferably from about 1% to about 90%, or more preferably from about 5% to about 80%, or more preferably from about 10% to about 70%, or more preferably from about 20% to about 60% of anthocyanins or flavonols on a dry weight basis and a substance selected from the group consisting of isoflavones, lignans, saponins, catechins, sterols, phenolic acids, sapogenins, and a combination thereof.

In one embodiment, the invention relates to a composition comprising an anthocyanin or flavonol extract from an edible bean source wherein said composition comprises from about 0.005% to about 99%, or more preferably from about 0.5% to about 99%, or more preferably from about 1% to about 90%, or more preferably from about 5% to about 80%, or more preferably from about 10% to about 70%, or more preferably from about 20% to about 60% of anthocyanins or flavonols on a dry weight basis, and one or more isoflavones, wherein the ratio of anthocyanins or flavonols to isoflavones on a dry weight basis is greater than the value selected from the group consisting of 0.0001, 0.001, 0.01, 0.1, 1.0, 10, 100, 1000, 10,000, and 100,000, preferably about 0.0001 to about 100,000.

In one embodiment, the invention relates to a composition comprising an anthocyanin or flavonol extract from an edible bean source wherein said composition comprises from about 0.005% to about 99%, or more preferably from about 0.5% to about 99%, or more preferably from about 1% to about 90%, or more preferably from about 5% to about 80%, or more preferably from about 10% to about 70%, or more preferably from about 20% to about 60% of anthocyanins or flavonols on a dry weight basis, and one or more lignans, wherein the ratio of anthocyanins or flavonols to lignans on a dry weight basis is greater than the value selected from the group consisting of 0.0001, 0.001, 0.01, 0.1, 1.0, 10, 100, 1000, 10,000, and 100,000, preferably about 0.0001 to about 100,000.

In one embodiment, the invention relates to a composition comprising an anthocyanin or flavonol extract from an edible bean source wherein said composition comprises from about 0.005% to about 99%, or more preferably from about 0.5% to about 99%, or more preferably from about 1% to about 90%, or more preferably from about 5% to about 80%, or more preferably from about 10% to about 70%, or more preferably from about 20% to about 60% of anthocyanins of flavonols on a dry weight basis, and one or more saponins, wherein the ratio of anthocyanins or flavonols to saponins on a dry weight basis is greater than the value selected from the group consisting of 0.0001, 0.001, 0.01, 0.1, 1.0, 10, 100, 1000, 10,000, and 100,000, preferably about 0.0001 to about 100,000.

In one embodiment, the invention relates to a composition comprising an anthocyanin or flavonol extract from an edible bean source wherein said composition comprises from about 0.005% to about 99%, or more preferably from about 0.5% to about 99%, or more preferably from about 1% to about 90%, or more preferably from about 5% to about 80%, or more preferably from about 10% to about 70%, or more preferably from about 20% to about 60% of anthocyanins or flavonols on a dry weight basis, and one or more catechins, wherein the ratio of anthocyanins or flavonols to catechins on a dry weight basis is greater than the value selected from the group consisting of 0.0001, 0.001, 0.01, 0.1, 1.0, 10, 100, 1000, 10,000, and 100,000, preferably about 0.0001 to about 100,000.

In one embodiment, the invention relates to a composition comprising an anthocyanin or flavonol extract from an edible bean source wherein said composition comprises from about 0.005% to about 99%, or more preferably from about 0.5% to about 99%, or more preferably from about 1% to about 90%, or more preferably from about 5% to about 80%, or more preferably from about 10% to about 70%, or more preferably from about 20% to about 60% of anthocyanins or flavonols on a dry weight basis, and one or more sterols, wherein the ratio of anthocyanins or flavonols to sterols on a dry weight basis is greater than the value selected from the group consisting of 0.0001, 0.001, 0.01, 0.1, 1.0, 10, 100, 1000, 10,000, and 100,000, preferably about 0.0001 to about 100,000.

In one embodiment, the invention relates to a composition comprising an anthocyanin or flavonol extract from an edible bean source wherein said composition comprises from about 0.005% to about 99%, or more preferably from about 0.5% to about 99%, or more preferably from about 1% to about 90%, or more preferably from about 5% to about 80%, or more preferably from about 10% to about 70%, or more preferably from about 20% to about 60% of anthocyanins or flavonols on a dry weight basis, and one or more phenolic acids, wherein the ratio of anthocyanins or flavonols to phenolic acids on a dry weight basis is greater than the value selected from the group consisting of 0.0001, 0.001, 0.01, 0.1, 1.0, 10, 100, 1000, 10,000, and 100,000, preferably about 0.0001 to about 100,000.

In one embodiment, the invention relates to a composition comprising an anthocyanin or flavonol extract from an edible bean source wherein said composition comprises from about 0.005% to about 99%, or more preferably from about 0.5% to about 99%, or more preferably from about 1% to about 90%, or more preferably from about 5% to about 80%, or more preferably from about 10% to about 70%, or more preferably from about 20% to about 60% of anthocyanins or flavonols on a dry weight basis, and one or more sapogenins, wherein the ratio of anthocyanins or flavonols to sapogenins on a dry weight basis is greater than the value selected from the group consisting of 0.0001, 0.001, 0.01, 0.1, 1.0, 10, 100, 1000, 10,000, and 100,000, preferably about 0.0001 to about 100,000.

In one embodiment, the invention relates to a composition comprising a lectin extract from an edible bean source wherein said composition comprises from about 0.005% to about 90%, or more preferably from about 0.5% to about 80%, or more preferably from about 5% to about 70%, or more preferably from about 10% to about 50%, or more preferably from about 15% to about 35%, or more preferably from about 20% to about 25% of lectins on a dry weight basis and a substance selected from the group consisting of isoflavones, lignans, saponins, catechins, sterols, phenolic acids, sapogenins, and a combination thereof.

In one embodiment, the invention relates to a composition comprising an lectin extract derived from an edible bean source wherein said composition comprises from about 0.005% to about 99%, or more preferably from about 0.5% to about 99%, or more preferably from about 1% to about 90%, or more preferably from about 5% to about 80%, or more preferably from about 10% to about 70%, or more preferably from about 20% to about 60%, or more preferably about 50% to about 60% of lectins on a dry weight basis and a substance or substances selected from the group consisting of isoflavones, lignans, saponins, catechins, phenolic acids, sapogenins, sterols, and a combination thereof, wherein the ratio of the lectins to the substance(s) on a weight basis in the composition is about than the value selected from the group consisting of 10,000:1, 1000:1, 500:1, 100:1, 50:1, 10:1, 1:1, 0.1:1, 0.01:1, 0.001:1, and 0.0001:1.

In one embodiment, the invention relates to a composition comprising an folic acid extract derived from an edible bean source wherein said composition comprises from about 0.0005% to about 99%, or more preferably from about 0.5% to about 80%, or more preferably from about 1% to about 60%, or more preferably from about 2% to about 55%, or more preferably from about 5% to about 40%, or more preferably from about 10% to about 25%, or more preferably about 15% to about 25% of folic acid on a dry weight basis and a substance or substances selected from the group consisting of isoflavones, lignans, saponins, catechins, phenolic acids, sapogenins, sterols, and a combination thereof, wherein the ratio of the folic acid to the substance(s) on a weight basis in the composition is about than the value selected from the group consisting of 10,000:1, 1000:1, 500:1, 100:1, 50:1, 10:1, 1:1, 0.1:1, 0.01:1, 0.001:1, and 0.0001:1.

In a preferred embodiment, the anthocyanin, flavonol, folic acid, isoflavone, or lectin extracts that comprise the compositions of the invention are made by the processes of the invention.

The extracts that comprise the compositions of the invention are from edible beans sources. The edible beans can be of any type and preferably are selected from the group consisting of black beans, red beans, kidney beans, dark red kidney beans, light red kidney beans, lentils, garbonzo beans, broadbeans, cowpeas, lima beans, chick peas, mung beans, mungo beans, peas, pigeon peas, yardlong beans, winged beans, lupins, pinto beans, white beans, great northern beans, mayo copa beans, french beans, and cranberry beans. Alternatively, legumes that are non-edible can also be used to make extracts that comprise compositions of the invention.

In one embodiment, the anthocyanin composition of the invention is from the black bean. In a further embodiment, the black bean anthocyanin composition can contain delphinidin, petunidin, peonidin, malvidin and combinations thereof.

In one embodiment, the extracts that comprise the compositions of the invention are from the light red kidney bean. In a further embodiment, the light red kidney bean flavonol extracts can contain quercitin and kaempferol and combinations thereof.

Such anthocyanin or flavonol compositions can be in the form of pharmaceutical compositions, in association with pharmaceutically acceptable carriers and excipients. The pharmaceutical compositions may be prepared by any of the known techniques in the art for preparing such pharmaceutical compositions, for example, by admixing the components. Typical carriers may be diluents, binders, disintegrants, and lubricants. Typically, diluents are sugars and include, for example, saccharose, mannitol, lactose, sorbitol, and cellulose preparations. Binders include starch pastes using, for example corn, wheat, rice, or potato starch, gelatin, tragacanth, methylcellulose, and/or polyvinlypyrrolidone. Common disintegrators include carboxymethyl starch, cross linked polyvinyl pyrrolidone, agar, or alginic acid or a salt thereof, such as sodium alginate. Common lubricants include silicic acid, talc, stearic acid or salts thereof, such as magnesium or calcium stearate, and/or polyethylene glycol.

The anthocyanin or flavonol compositions according to the invention may also include one or more active agents, such as vitamins (for example Vitamin A, Vitamin B, Vitamin C, Vitamin D, Vitamin E, and Vitamin K), minerals, (for example magnesium, iron, zinc, calcium, and manganese in the form of pharmaceutically acceptable salts), chemotherapy agents including anti-multi-drug resistant compounds (for example alkylating agents, anti-metabolites, vinca alkaloids, antibiotic cytotoxics), immune stimulators, (for example, any interferon, interleukin, and growth hormones/growth factors), and antioxidants.

The pharmaceutical compositions of the invention are those that are suitable for oral, optical, buccal, rectal, parental, and transdermal administration. The route of administration will depend on the condition that is to be treated as well as the physical state of the patient.

Compositions suitable for oral administration maybe presented in discrete units, such as capsules, cachets, lozenges, or tablets, each containing a predetermined amount of the extract; as a powder or granules; as a solution or as a suspension in an aqueous or non-aqueous liquid; or as an oil in water or water in oil emulsion. Such compositions may be prepared by any suitable method of pharmacy which includes the step of bringing into association the composition or extract of the present invention and one or more suitable carriers (which may contain one or more accessory ingredients as noted above). In general the compositions of the invention are prepared by uniformly and intimately admixing the extract with a liquid or a finely divided solid carrier, or both, and then if necessary, shaping the resulting mixture. For example, a tablet may be prepared by compressing or moulding a powder or granules containing the extract, optionally, with one or more accessory ingredients. Compressed tablets may be prepared by compressing in a suitable machine, the extracts in the form of a powder or granules optionally mixed with a binder, lubricant, inert diluents, and/or surface active/dispersing agents. Moulded tablets may be made by moulding, in a suitable machine, the powdered compound moistened with an inert liquid barrier.

The anthocyanin or flavonol compositions may be useful in a variety of applications, such as nutritional supplements, pharmaceutical preparations, vitamin supplements, food additives, liquid, solid, or powder preparations, including beverages or drinks, sterile injectable solutions, tablets, coated tablets, capsules, drops, suspensions, or syrups, ointments, lotions, creams, pastes, gels, or the like. Compositions of the invention may also be useful as supplements to herbal remedies and treatments.

The anthocyanin or flavonol compositions and extracts of the present invention may be useful as natural colorants in food, beverages, confections, cosmetic, pharmaceutical, or nutritional supplement products. A composition that is to be used as a colorant in accordance with the invention is normally placed in a suspending medium to form a stock suspension which is further diluted prior to the application to the product that is to be colored.

Additionally, the compositions and extracts of the invention maybe used to supplement livestock or animal feed. In this manner, the food products may be used in a therapeutic manner to prevent or alleviate the symptoms or conditions that are sensitive to anthocyanin or flavonoid compounds, such as urogenital infections.

There is considerable epidemiological evidence that anthocyanin pigments and flavonols may have preventive and therapeutic roles in a number of human diseases. These effects maybe due to their potent anti-oxidant activity. Accordingly, the present invention further provides a method of treating or reducing the probablitity of developing a condition in a human, comprising administering an effective amount of an anthocyanin or flavonol composition or extract of the invention to a human in need thereof, wherein the condition is selected from the group consisting of cancer, stroke, elevated blood cholesterol, hypertension, myocardial infarction, diabetes, obesity, and inflammatory disorders. The present invention further provides a method of alleviating stress in a human, comprising administering the anthocyanin or flavonol composition of the invention. Also provided is a method of improving night-vision in a human, comprising administering an effective amount of an anthocyanin or flavonol composition of the invention to a human in need thereof.

The invention provides a method of treating or preventing cancer comprising administering to a human in need thereof an effective amount of a composition of the invention. The invention provides a method of treating or preventing stroke comprising administering to a human in need thereof an effective amount of a composition of the invention. The invention provides a method of treating or preventing elevated blood cholesterol comprising administering to a human in need thereof an effective amount of a composition of the invention.

The invention provides a method of treating or preventing hypertension comprising administering to a human in need thereof an effective amount of a composition of the invention.

The invention provides a method of treating or preventing myocardial infarction comprising administering to a human in need thereof an effective amount of a composition of the invention. The invention provides a method of treating or preventing diabetes comprising administering to a human in need thereof an effective amount of a composition of the invention. The invention provides a method of treating or preventing obesity comprising administering to a human in need thereof an effective amount of a composition of the invention.

The invention provides a method of treating or preventing an inflammatory disorder comprising administering to a human in need thereof an effective amount of a composition of the invention.

The invention provides a method of enhancing night vision comprising administering to a human in need thereof an effective amount of a composition of the invention.

The invention provides a method alleviating stress in a human comprising administering to a human in need thereof an effective amount of a composition of the invention.

The following examples illustrate certain embodiments of the invention and are not construed to be a limitation thereof.

### EXAMPLES

### Example 1

Experiments have been conducted to demonstrate the presence of anthocyanins and flavonols (polyphenolic compounds) in the bean process streams. Initial evaluations were conducted for the confirmation of anthocyanins. Anthocyanins change colors based on pH. A solution of anthocyanins at pH 1 will have characteristic orange red-color. This color diminishes to clear at pH 4 and then gradually becomes blue at higher pH levels. A colorimetric test for the presence of anthocyanins is by pH Differential. This assay determines total anthocyanin content at pH 1.0 and 4.5 measured at a wavelength of 510 nm (Wrolstad, R. E., (1976) “Color and Pigment Analysis in Fruit Products” Ag. Exp. Station, Oregon State University, Station Bulletin 624 (Reprinted May 1993)).

Black bean effluent from the blanch step of bean processing was tested colorimetrically for the presence of anthocyanins. As recovered, the blanch process water was dark blue-black at pH 5.26. Test by pH adjustment with glacial acetic acid to a pH of 2.0 resulted in a characteristic bright red hue. The sample was further analyzed by the pH differential method and found to have 0.014% anthocyanins on an as is basis. Dark red kidney bean blanch effluent did not show evidence of anthocyanins.

### Example 2

Separation of individual moieties of anthocyanins and flavonols was demonstrated with blanch water effluent from black and dark red kidney beans. Three hundred and fifty milliliters of effluent was applied to a Purolite AP-250 resin for the purpose of absorption. Column effluent went through a series of color changes as loading occurred. Effluent went from clear to green to dark purple for the black bean blanch water. At this point the column was saturated with color compounds (anthocyanins). Color compounds were then eluted with 350 ml of 70% ethanol. Color separation occurred as the elution progressed. Distinct color bands associated with the identified compounds eluted from the column. Fraction 1 was a dark blue black that turned bright red upon acidification to pH 3.27. This appeared to be excess blanch water. However, fraction 2 eluted as a rust red that turned to a dark red purple upon acidification to 2.68. Fraction 3 eluted as a blue and turned to a vibrant violet upon acidification to pH 3.11.

Compounds identified in black beans have unique color properties that relate to the unique bands separated during ethanol elution. Delphinidin (red), petunidin (violet) and malvidin (blue) have colors identities that are associated with the individual color bands.

The above procedure was repeated with dark red kidney blanch water with results as expected from literature. Primary color band eluted during this test was a bright yellow band characteristic of the flavanols: quercitin 3-glucopyranoside and kaempferol 3-glucopyranoside.

### Example 3

Concentration of color compounds from black bean blanch water was demonstrated utilizing a KOCH nano-filter with a molecular cut-off of 200-500 M. W. As measured by color breakthrough, a six-fold concentration of the color compounds (anthocyanins) was achieved by removal of water and minerals. 22.5 kg of black bean blanch water was reduced to 3.6 kg of dark concentrate. There was no evidence of color passing through the membrane with the remaining fraction (17.7-kg) being clear. Concentrated effluents were freeze dried and held for evaluation.

### Example 4

Approximately 11.35 kilograms of black, light red kidney, dark red kidney, chick peas and red beans were separately processed for commercial production. The beans were first blanched at 145 degrees Fahrenheit for 30 minutes and again at 165 degrees Fahrenheit for an additional 30 minutes in a 0.35% aqueous solution of sodium chloride (by weight of the beans). The aqueous waste process stream from the two blanch treatments were pooled for analysis. The process stream was subjected to reverse osmosis to obtain a liquid concentrate that was subsequently dried to yield a powder.

The content of the powder was analyzed for the presence of the following compounds and constituents as shown in the table below. Fat content was determined by method no. Bc 3-49 of AOCS, crude protein by method no. Ba 3-49 of AOCS, ash content by method no. Ba 5a-49 of AOCS, folic acid by method no. 944.12 of AOAC. Isoflavone content was obtained by the methods described in J. Chromatog. A. 913:397-413 (2001). The flavonol and anthocyanin content was obtained by published methods. See e.g. Revilla et al., J. Chromatogr A. 915(1-2): 53-60 (2001). Units represent amount of the compound or substance based on the dry weight of the powder. MFB stands for “Moisture Free Basis.”

| | | | EDIBLE BEAN | | | | |
|---|---|---|---|---|---|---|---|
| ANALYSIS | | | | Light Red | Dark Red | | |
| (MFB) | (form) | units | Black Bean | Kidney | Kidney | Chick Pea | Red Bean |
| Ash | | % | 4.91 | 6.54 | 6.26 | 12.51 | 5.28 |
| Protein | | % | 17.45 | 19.21 | 17.34 | 13.47 | 18.77 |
| Fat (pet. | | % | 0.10 | 0.09 | 0.07 | 0.01 | 0.09 |
| ether) | | | | | | | |
| Flavonol | (Quercitin) | mg/g | 0.28 | 0.48 | 4.52 | 0.12 | na* |
| | (Kaempferol) | | 0.16 | 0.06 | 0.31 | 0.02 | na |
| Anthocyanin | (Delphinidin) | mg/g | 5.29 | na | nd* | na | nd |
| | (Cyanidin) | | nd | na | 0.02 | na | 0.03 |
| | (Petunidin) | | 6.95 | na | 0.03 | na | 0.07 |
| | (Peonidin) | | 0.10 | na | 0.01 | na | 0.13 |
| | (Malvidin) | | 3.51 | na | 0.01 | na | 0.01 |
| Folic Acid | | ug/100 g | 430.65 | 352.25 | 403.05 | 485.87 | 335.69 |
| Isoflavones | Total (12 | mg/kg | 275.62 | 65.48 | 150.29 | 44.83 | 1072.44 |
| | forms) | | | | | | |

*na not available
*nd none detected

### Example 5

### Anthocyanin Black Bean Extract Tablet Formulation

An HPLC purified anthocyanin powder extract from the black bean (100 mg; 80% total content anthocyanins), lactose, and a portion of the cross-linked polyvinylpyrrolidone is granulated with an aqueous solution of the polyvinylpyrrolidone and polysorbate 80. The granules are dried, reduced to a suitable size, and mixed with stearic acid, magnesium stearate, and remaining cross-linked polyvinylpyrrolidone. The mixture is compressed into individual tablets yielding a tablet weight of 500 mg.

The composition of the tablet is shown below:

| | | |
|---|---|---|
| Anthocyanin extract from the black bean | 100 | mg |
| Polyvinylpyrrolidone | 25.0 | mg |
| Polysorbate 80 | 5.00 | mg |
| Lactose Anhydrous | 330 | mg |
| Cross-linked polyvinylpyrrolidone | 30.0 | mg |
| Stearic Acid | 5.0 | mg |
| Magnesium Stearate | 5.0 | mg |

### Example 6

### Addition of Anthocyanin Black Bean Extract to a Beverage Product

Eight hundred grams of a black bean extract prepared as described in Example 4 was added slowly with mixing to a drum containing approximately 500 gallons of a colorless nutritional sports beverage. Upon acidification, the beverage changed from colorless to a bright red color.

### Example 7

### Addition of Anthocyanin Black Bean Extract to a Food Product

Seventy-five milligrams of an HPLC purified anthocyanin powder extract from the black bean (80% total content anthocyanins), was added to approximately 100 grams of a yogurt preparation. The powder was well suspended and particulate was not visible.

Although the foregoing invention has been described in some detail by way of illustration and example for purposes of clarity of understanding, this invention is not limited to the particular embodiments disclosed, but is intended to cover all changes and modifications that are within the spirit and scope of the invention as defined by the appended claims.

All publications and patents mentioned in this specification are indicative of the level of skill of those skilled in the art to which this invention pertains. All publications and patents are herein incorporated by reference to the same extent as if each individual publication or patent application were specifically and individually indicated to be incorporated by reference.

What is claimed is:

1. A process of obtaining anthocyanin or flavonol compounds comprising isolating the anthocyanin or flavonol compounds from an edible bean processing stream, wherein the isolation step comprises:
(a) providing said edible beans;
(b) contacting said edible beans with the edible bean processing stream to produce an aqueous extract; and
(c) separating said aqueous extract from said edible beans;
wherein the edible bean processing stream is an aqueous solution comprising a blanch or conditioning solution employed in edible bean processing.

2. The process of claim 1, further comprising concentrating the extract of (c) to form a liquid concentrated extract.

3. The process of claim 2, further comprising drying said concentrated extract to form a powder.

4. The process of claim 2, further comprising
(a) contacting said concentrated extract with a resin, wherein said resin absorbs anthocyanin or flavonol compounds, or both;
(b) eluting a fraction of said absorbed extract from said resin to obtain a fractionated extracts with a solution comprising an organic solvent; and
(c) drying said fractionated extract to remove the organic solvent.

5. The process of claim 4, further comprising concentrating the extract of (c) to form a liquid concentrated extract.

6. The process of claim 5, further comprising drying said concentrated extract to form a powder.

7. The process of claim 1, wherein said contacting of (b) is conducted at about 40 to about 200 degrees Fahrenheit.

8. The process of claim 1, wherein said contacting of (b) is conducted at about 130 to about 180 degrees Fahrenheit.

9. The process of claim 2, wherein said solution is concentrated by a method selected from the group consisting of reverse osmosis, ultrafiltration, and nanofiltration.

10. The process of claim 1, wherein said contacting of (b) is performed for about 5 to about 75 minutes.

11. The process of claim 1, wherein said edible bean source is selected from the group consisting of black beans, red beans, dark red kidney beans, light red kidney beans, lentils, chickpeas, broadbeans, cowpeas, lima beans, mung beans, mungo beans, peas, pigeon peas, yardlong beans, winged beans, lupins, pinto beans, white beans, great northern beans, french beans, and cranberry beans.

18. The process of claim 1, wherein said extract comprises 0.005% to 30% anthocyanins or about 0.001% to about 25% flavonols, or both, on a dry weight basis.

19. The process of claim 18, wherein said extract comprises 0.5% to 10% anthocyanins or about 0.01% to about 5.0% flavonols, or both, on a dry weight basis.

20. The process of claim 2, wherein said extract comprises about 0.01% to about 75% anthocyanins or about 0.01% to about 50% flavonols, or both, on a dry weight basis.

21. The process of claim 20, wherein said extract comprises about 0.1% to about 15% anthocyanins or about 0.1% to about 25% flavonols, or both, on a dry weight basis.

22. The process of claim 3, wherein said extract comprises about 0.1% to about 65% anthocyanins or about 0.1% to about 50% flavonols, or both, on a dry weight basis.

23. The process of claim 4, wherein said extract comprises about 0.1% to about 75% anthocyanins or about 0.1% to about 65% flavonols, or both, on a dry weight basis.

24. The process of claim 5, wherein said extract comprises about 0.1% to about 90% anthocyanins or about 0.1% to about 90% flavonols, or both, on a dry weight basis.

25. The process of claim 6, wherein said extract comprises about 5.0% to about 99.5% anthocyanins or about 0.5% to about 99% flavonols, or both, on a dry weight basis.

26. The extract obtained by the process according to claim 18.

27. The extract obtained by the process according to claim 19.

28. The extract obtained by the process according to claim 20.

29. The extract obtained by the process according to claim 21.

30. The extract obtained by the process according to claim 22.

31. The extract obtained by the process according to claim 23.

32. The extract obtained by the process according to claim 24.

33. The extract obtained by the process according to claim 25.

34. The extract obtained by the process according to claim 25.

35. A composition comprising an anthocyanin or flavonol extract from an edible bean source, said composition comprising from about 0.005% to about 99% of anthocyanins or about 0.005% to about 99.0% flavonols, or both, on a dry weight basis and a substance selected from the group consisting of isoflavones, lignans, saponins, catechins, sterols, phenolic acids, sapogenins, and a mixture thereof.

36. A composition according to claim 35, wherein said extract is prepared by the process of claim 2.

37. A composition according to claim 35, wherein said extract is prepared by the process of claim 3.

38. A composition according to claim 35, wherein said extract is prepared by the process of claim 5.

39. A composition according to claim 35, wherein said extract is prepared by the process of claim 6.

40. The composition of claim 35, wherein said anthocyanin is selected from the group consisting of delphinidin 3-glucoside, peonidin 3-glucoside, petunidin 3-glucoside, malvidin 3-glucoside and a combination thereof.

41. The use of the composition of claim 35 as a natural colorant in a food or beverage product.

42. A food or beverage product comprising the composition of claim 35.

43. A pharmaceutical product comprising the composition of claim 35.

44. A cosmetic product comprising the composition of claim 35.

45. A nutritional supplement product comprising the composition of claim 35.

46. A method of treating or preventing cancer comprising administering to a human in need thereof an effective amount of the composition of claim 35.

47. A method of treating or preventing stroke comprising administering to a human in need thereof an effective amount of the composition of claim 35.

48. A method of treating or preventing elevated blood cholesterol comprising administering to a human in need thereof an effective amount of the composition of claim 35.

49. A method of treating or preventing hypertension comprising administering to a human in need thereof an effective amount of the composition of claim 35.

50. A method of treating or preventing myocardial infarction comprising administering to a human in need thereof an effective amount of the composition of claim 35.

51. A method of treating or preventing diabetes comprising administering to a human in need thereof an effective amount of the composition of claim 35.

52. A method of treating or preventing obesity comprising administering to a human in need thereof an effective amount of the composition of claim 35.

53. A method of treating or preventing an inflammatory disorder comprising administering to a human in need thereof an effective amount of the composition of claim 35.

54. A method of enhancing night vision comprising administering to a human in need thereof an effective amount of the composition of claim 35.

55. A method of alleviating stress in a human comprising administering to a human in need thereof an effective amount of the composition of claim 35.

56. The composition of claim 35, wherein said composition possesses anti-viral or anti-microbial activity.

57. A process of obtaining folic acid, comprising isolating the folic acid from an edible bean processing stream.

58. A process of obtaining lectins comprising isolating the lectins from an edible bean processing stream.

59. A process of obtaining isoflavones comprising isolating the isoflavones from an edible bean processing stream.
